(19) United States
(12) Patent Application Publication
(10) Pub. No.: US 2025/0115429 A1
(43) Pub. Date: Apr. 10, 2025

(54) SYSTEMS AND METHODS FOR AUTOMATED STORAGE AND RETRIEVAL OF GOODS

(71) Applicant: AUTOBOTIT INC., Clinton, TN (US)

(72) Inventor: Rodney J. KING, Clinton, TN (US)

(73) Assignee: AUTOBOTIT INC., Clinton, TN (US)

(21) Appl. No.: 18/912,237

(22) Filed: Oct. 10, 2024

Related U.S. Application Data
(60) Provisional application No. 63/589,103, filed on Oct. 10, 2023.

(51) Int. Cl. B65G 1/137; B61B 13/02; B61C 9/38; G06Q 10/087; G06T 7/70

(52) U.S. Cl. CPC B65G 1/1371; B61B 13/02; B61C 9/38; G06Q 10/087; G06T 7/70; B65G 2203/0216

(57) ABSTRACT

A control system for a three-dimensional storage and distributing system is disclosed. The control system may comprise a track included a section used for horizontal operation and a section used for vertical operation, wherein the track includes a plurality of impressions designed to mesh with a toothed rotational device, wherein the track includes a curved portion to facilitate transition of said toothed rotational devices from a x-direction on a horizontal plane to a y-direction on a vertical plane, and vice versa, wherein the horizontal portion of the track works on the horizontal plane. The control system may comprise a plurality of carriages, wherein the carriages use a four toothed rotational device for movement. The control system may comprise a plurality of actuated turners comprising a receiver for the carriages, wherein the receiver allows for rotating the carriages in the horizontal plane, with or without movement in the y-direction. The control system may comprise a control device.

### CROSS-REFERENCE TO RELATED APPLICATIONS

This disclosure relates to U.S. Provisional Application No. 63/589,103 (Attorney Docket No. 16440.6000-00000), titled “SYSTEMS AND METHODS FOR AUTOMATED STORAGE AND RETRIEVAL OF GOODS,” filed Oct. 10, 2023, the contents of which are incorporated herein in their entirety.

### TECHNICAL FIELD

The present disclosure relates generally to devices, systems, and automated methods of storage and retrieval of real goods and related methods for optimization of storage and retrieval. More specifically, and without limitation, this disclosure relates to the use of artificial intelligence/machine learning/algorithms implemented on devices capable of processing instructions consistent with the algorithms and relational storage methods, to optimize storage and retrieval for speed, efficiency, and inventory control and management. The systems and methods disclosed herein may be used in various applications, such as, but not limited to: retail logistics, manufacturing, distribution, short-term storage, and long-term storage.

### BACKGROUND

In situations where goods must be stored in a single location for storage and/or distribution the tracking, securing, and delivery of stored goods is labor-intensive and prone to human error. Depending on the nature of the stored goods they can also be vulnerable to misplacement and/or theft. Retail environments have issues with labor costs, labor shortages, shrinkage due to spoilage and/or theft, and deep levels of employee and customer dissatisfaction. Storage in manufacturing and distribution environments poses many safety concerns regarding heavy equipment, heavy objects, operating at height, and falling objects. Short and long-term storage environments require interfaces for each storage location that are human-accessible and concerns over access, security, and safety. Existing methods of automating these environments suffer from a variety of shortcomings, including overly complex systems, requirements for automated systems to coexist or operate in tandem with human beings, and a lack of flexibility.

In view of the foregoing, the inventors have identified that there is a need for an improved system for the automation of the storage and retrieval of real goods.

### SUMMARY

In view of the foregoing, embodiments of the present disclosure provide automated systems and methods for the storage and retrieval of real goods.

According to some embodiments, a track system for a three-dimensional storage and distributing system can comprise an improved track design comprising a track included a section used for horizontal operation and a section used for vertical operation, wherein the track includes a plurality of individual members designed to mesh with a toothed rotational device, wherein the members may comprise individual cylindrical members, wherein the members allow for a low-vibration interface between the track and the toothed rotational device, wherein the plurality of individual members are rounded and able to spin to encourage toothed rotational device to slide back to mesh with the members when slight misalignments occur, wherein the members are able to rotate to allow for seamless movement, wherein each of the plurality of members is attached to a conductive structural member, wherein the track may include a portion to facilitate transition of said toothed rotational devices from a x-direction on a horizontal plane to a y-direction on a vertical plane, and vice versa, wherein the horizontal portion of the track works on the horizontal plane, wherein the track includes a gap to allow a passage of a guide during the transition, wherein the horizontal portion of the track running in the x-direction are interrupted along their length by a plurality of trapdoors, wherein the trapdoor includes a hinge on one side and wherein the trapdoor is torsion mounted on the other side so the hinge is biased to be in the open position, wherein the trapdoor includes one or more elastic members to allow for decreased oscillation and guidance of said the toothed rotational device during a horizontal-vertical transition, wherein the trapdoor includes a trapdoor gap in between the rollers to allow the ability to temporarily close the gap in the track while in the down position, wherein the trapdoor may provide a surface to provide a pushing force to assist in the transition; a plurality of carriages, each of said carriages comprising a drive system using a motor excluding a braking system, wherein the motor excludes a sensor to indicate location of the carriage on the track, wherein the drive system uses a four toothed rotational device for movement, wherein the drive system uses gearing configured to allow slowing or stopping of the motor, wherein the drive system includes a drive shaft of the motor driving a primary axle through a single gear set, wherein the drive system includes a secondary axle driven by the primary axle using a non-slip belt or chain, rolling guides mounted fore and aft of said toothed rotational devices, wherein the rolling guides engage the trapdoor during transitions, whereby said carriages can be propelled up and down the vertical rails; a plurality of actuated turners comprising a receiver for the carriages, wherein the receiver allows for rotating the carriages in the horizontal plane, with or without movement in the y-direction, wherein the receiver allows the carriages to continue operation after the rotation; and a visual acquisition system, wherein the visual system may identify carriages through visual information from a camera, wherein the visual system identifies the relative location of the carriage compared to other system elements, wherein the visual system identifies the carriages' position in relation to the actuated turner before, during, and after operation of the receiver, and one or more control devices comprising a processor and a non-transitory memory storing instructions to perform operations when executed by the processor including controlling the plurality of carriages and communication with other system elements, wherein the one or more control devices may be in operable communication with a variety of sensors to facilitate operation and navigation of the track, wherein the one or more control devices may control turner operations and communicate with other system elements, whereby the carriages move along the rails, communicating with the turners and the delivery systems, and activating an emergency shut-off to prevent damage to the track system.

In some embodiments, the track can further comprise a plurality of horizontal rails running in the z-direction, perpendicular to the horizontal rails running in the x-direction, wherein the horizontal rails running in the z-direction are connected to said horizontal rails in the x-direction with the actuated turners, wherein the horizontal rails running in the z-direction are interrupted along their length by a plurality of trapdoors.

In some embodiments, the track system can comprise a bin manipulator mounted to each of the carriages, wherein the bin manipulators are each comprised of a framework for transporting bins, wherein the framework includes an open bottom on the carriage allowing the transportation of bins of differing heights, wherein the visual acquisition system may be mounted to each of the carriages and is configured to assist the alignment of the carriage with a variety of system elements to allow operation of the bin manipulators, wherein the visual acquisition system ensures alignment of the carriage within the turner during turner operation, wherein the visual acquisition system ensures alignment of the carriage to the shelves, wherein the visual acquisition system utilizes visual cues to identify its relative location within the system, wherein the visual acquisition system is configured to assist the alignment of the carriage to allow operation of the bin manipulators, wherein the visual acquisition system identifies unique bins using visual information, wherein the visual acquisition system identifies the presence of bins, wherein the visual acquisition system identifies the absence of bins, wherein the visual acquisition system identifies the presence of the item within the bin, wherein the visual acquisition system identifies the item within the bin using visual information, and wherein the visual acquisition system confirms the successful manipulation of a bin.

In some embodiments, the track system can comprise a delivery system comprising a plurality of delivery interfaces comprising a motorized collection of delivery shelves, wherein the delivery shelf is configured to interact directly with the carriages operating on the track operating in the x-direction without moving in the y-direction, wherein the delivery shelf is configured to move in a vertical y-direction, wherein the delivery shelf is configured to interact with a customer interface configured to deliver items to respective addresses by consulting a database associating the items with the addresses.

In some embodiments, the track system can comprise an electronic control system, including a cloud configured to connect the customer interface and the vendor interface, wherein the database comprises inputs from the customer interface and the vendor interface to associate the items with the addresses.

### BRIEF DESCRIPTIONS OF FIGURE AND APPENDIX IMAGES

The accompanying drawings, which comprise a part of this specification, illustrate several embodiments and, together with the description, explain the principles and features of the disclosed embodiments. In the drawings:

FIG. 1 is a block diagram of a control system configured to store and retrieve real goods consistent with the present disclosure;

FIG. 2 is a block diagram illustrating a customer interface and a vendor interface should consistent with the present disclosure;

FIG. 3 is a schematic of a hive system configured to store and retrieve real goods consistent with the present disclosure;

FIG. 4 is a schematic of a track design;

FIG. 5, FIG. 6, and FIG. 7 are schematics of trapdoor design;

FIG. 8 is a block diagram of a turner consistent with the present disclosure;

FIG. 9 is a schematic of a turner consistent with the present disclosure;

FIG. 10 is a block diagram of a bot consistent with the present disclosure;

FIG. 11 and FIG. 12 are schematics of a bot consistent with the present disclosure;

FIG. 13 is a schematic of a delivery system consistent with the present disclosure.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures can be rearranged, combined, or divided without departing from the envisioned embodiments. Similarly, additional steps may be added, or steps may be removed without departing from the envisioned embodiments. Thus, the materials, methods, and examples are illustrative only and are not intended to be necessarily limiting.

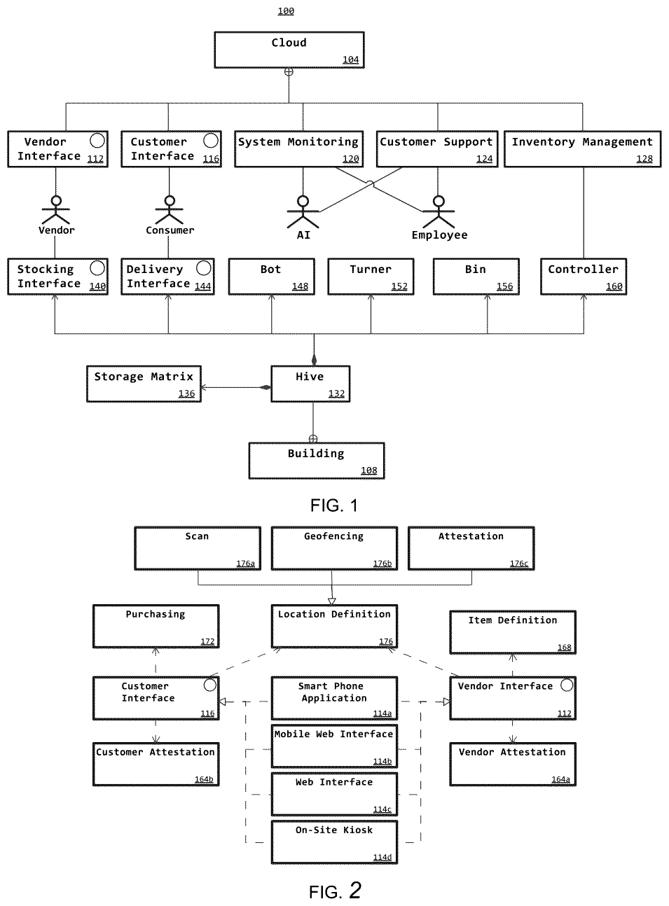

FIG. 1 is a schematic of a control system 100 with focus on functionality that operates within the Cloud 104 and within each physical location, such as one or more buildings 108. Cloud functionality includes, but is not limited to, several subsystems, including a Vendor Interface 112, a Customer Interface 116, System Monitoring 120, Customer Support 124, and Inventory Management 128. Within a Building 108 there are one or more Hives 132, which include a Storage Matrix 136, one or more Stocking Interfaces 140, one or more Delivery Interfaces 144, one or more Bots 148, four or more Turners 152, one or more Bins 156, and at least one Controller 160.

Controller 160 may include a processor. The processor may be connected to a non-transitory computer readable memory, connected over the cloud, a network, or locally, that comprises instructions configured to be executed by a processor. The instructions may include the operation of one or more components of the control system 100 consistent with the present disclosure. The controller 160 may be connected to a communication module. The communication module may be configured to send instructions to one or more actuators, motors, or drive systems associated with the components of control system 100. The communication module may be configured to send instructions to other processors within one or more components of control system 100, and the processors within the components may be configured to execute the instructions and/or determine instructions to execute based on the received instructions.

The Inventory Management 128 subsystem interfaces with Controllers 160 within each Hive 132 that are in turn within each Building 108. It is through this subsystem that vendors requesting to push items through the Vendor Interface 112 are able to have the Hive 132 accept items through the Stocking Interface 140. Consumers can use the Customer Interface 116 to request or purchase items and receive them from the Hive 132 through the Delivery Interface 144. It is possible for the Vendor Interface 112 and Customer Interface 116 to be the same interface or just different aspects of the same interface as well as completely different interfaces. In the same manner, it is possible for the Stocking Interface 140 and the Delivery Interface 144 to be the same interface, part of the same interface, or completely different interfaces.

System Monitoring 120 can observe and record all application behavior in the Cloud 104 as well as getting feedback from all Hive 132 elements, as well as additional sensors from the Building 108, such as microphones, cameras, or LIDAR, radar, or infrared sensors. The microphones, cameras, or sensors may be used to determine an arrival or a departure of a package or a placement of the package within the control system 100. Given the potential for large amounts of data coming through the System Monitoring 120 subsystem AI would be used to filter through and potentially act upon data or pass it along to humans for further analysis. Customer Support 124 would also have access to either all the data gathered by the System Monitoring 120 subsystem, or a subset of it. Customer Support 124 would also be either assisted or replaced by AI systems.

Bots 148 are semi-autonomous automatons that traverse through the Storage Matrix 136 to take items from the Stocking Interface 140, store them, and later deliver them to the Delivery Interface 144. Bots 148 may include a processor, a memory configured to store instructions operable by the processor to actuate one or more systems of the Bots 148 to accomplish moving, direction changes, or picking up, dropping, sliding, or conveying of items. Items are stored and moved within the Storage Matrix 136 in Bins 156. Turners 152 allow for direction changes of the Bots 148 while traversing through the Storage Matrix 136. The Controller 160 provides supervision and control to the Bots 148, Turners 152, Stocking Interface 140, and Delivery Interface 144 as they interact with other elements of the Hive 132 and with outside actors. It also tracks the status and locations of Bins 156 and the Items contained within them (or their status as being empty) through the Storage Matrix 136.

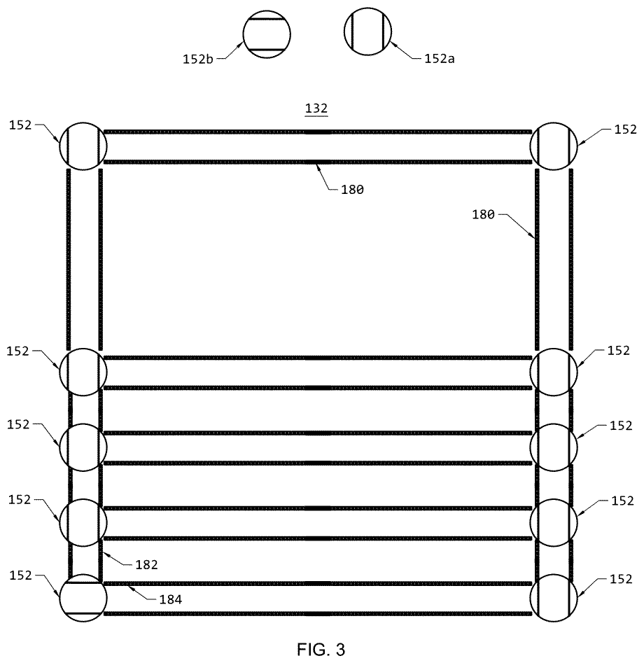

FIG. 2 shows how the Vendor Interface 112 and Customer Interface 116 provide a virtual method for defining items being placed in a specific Hive 132. This could be performed through a web interface 114a, a mobile web interface 114b, a smart phone application 114c, or an on-site kiosk 114d. These interfaces could be completely different applications or different aspects of the same application.

The Vendor Interface 112 requires some type of Vendor Attestation 164a and the Customer Interface 116 requires some type of Customer Attestation 164b. Any standard method of logging in, including, but not limited to, username and password, web cookies, authentication applications, text passcodes, email passcodes, scanned QR codes, virtual keys, or physical electronic keys could be used to provide this attestation. The Vendor Interface 112 also requires some method of Item Definition 168 to define the specific instance of an item being pushed into the Hive 132. The Customer Interface 116 requires a method of Purchasing 172, which would use standard methods of eCommerce.

Both the Vendor Interface 112 and the Customer Interface 116 need a method for Location Definition 176. Some type of Scan 176a, such as a QR Code, Bar Code, NFC Signal, Wi-Fi Signal, Bluetooth Signal, or any other image-based or RF-based scan could provide this Location Definition 176 method. Geofencing 176b could use GPS to check to see if the device hosting the Vendor Interface 112 and/or Customer Interface 116 is within a specific geographic area. The vendor or customer could also use Attestation 176c to declare their location through the Vendor Interface 112 and/or Customer Interface.

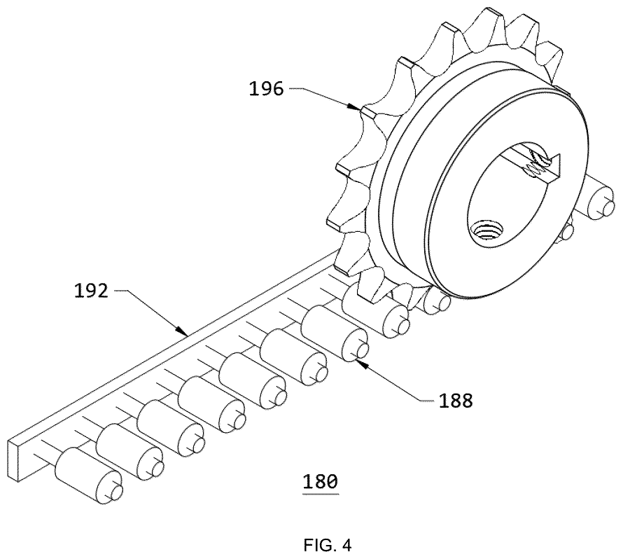

FIG. 3 shows a layout of a Hive 132. Hive 132 is an improvement of a hive described in U.S. Pat. No. 7,381,022 B1 due in part to the addition of Turners 152. Where prior art required the use of elevation change to change direction on the Tracks 180 at the top level of the Hive 132, the addition of Turners 152 allows for the top level to exist on a single plane. Turners 152 provide the ability to change direction by ninety degrees, which simplifies the process of moving through the Hive 132. Moving from N-S Tracks 182 to E-W Tracks 184 and vice versa is handled by Turners 152. While in Forward Position 152a access is provided to the N-S Tracks 182. While in Turned Position 152b access is provided to the E-W Tracks 184.

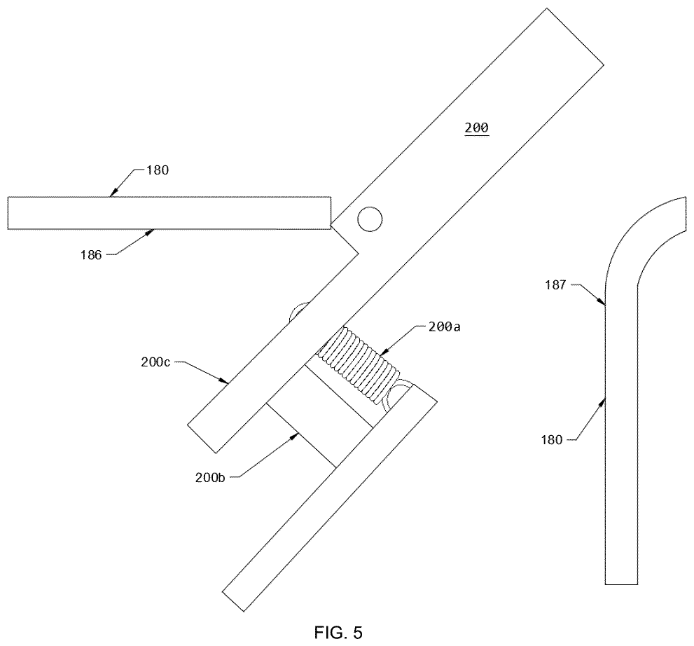

FIG. 4 shows an improvement to the horizontal track design. Through experimentation and research, it was found that the Drive Sprocket 196 tended to climb out of tracks based on chain. After several iterations and prototypes the solution of Roller Track 180 was developed. By eliminating elements that provide purchase for the Drive Sprocket 196 to ride up on, the Roller Track 180 is able to improve performance and reliability. Each Roller 188 is fastened to a Conductive Backplane 192. The Conductive Backplane 192 provides electrical power, stability, and additional strength to each Roller 188.

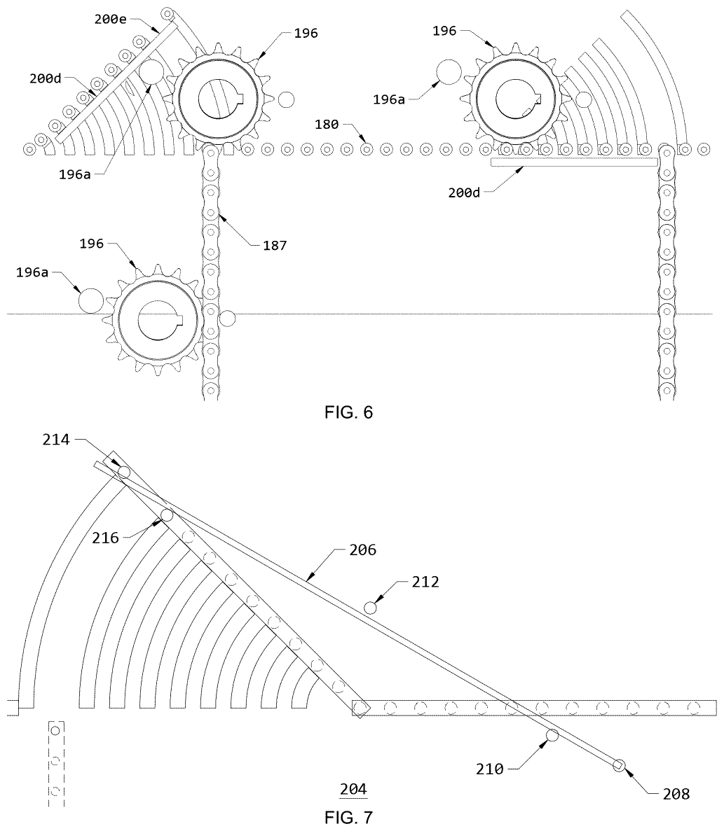

FIG. 5 shows a Trapdoor 200 that allows for transition between Horizontal Track 186 and Vertical Track 187. The addition of the Pull Spring 200a and the Bumper Spring 200b allow for improved performance over the original design of which only included the Trapdoor Counterweight 200c. The Pull Spring 200a assists gravity in rapidly pulling the Trapdoor 200 into an open position. This allows for faster and more reliable operation of the Trapdoor 200, which, in prior art, would oscillate in pendulum like motion. This caused delays and potential malfunctions, which were eliminated by this design. The use of the Bumper Spring 200b allows the trapdoor to provide appropriate pressure to the Bot as it goes along the Track 180 from the Vertical Track 187 to the Horizontal Track 186 and vice versa. This allows the Trapdoor 200 to move out of the way while the Bumper Spring 200b returns the Trapdoor 200 to a proper position for another bot to push down for horizontal operation.

FIG. 6 demonstrates the operation of the Drive Sprocket 196 along the Vertical Track 187 as it transitions onto the Roller Track 180. To allow for proper vertical to horizontal and horizontal to vertical transitions it is necessary to apply a small pushing force. Through experimentation it was found that the use of a Trapdoor Push Plate 200d along with a Trapdoor Guide 196a provided the best results. These two elements provide a consistent interface that prevents unintentional binding and a reliable and repeatable amount of force to assist in the transition. The use of Roller Track 180 also allows for a Trapdoor Gap 200e to be designed into the system. This eliminates the gap required by the guide described in U.S. Pat. No. 7,381,022 B1 during forward operation and preserves it for transitions.

FIG. 7 shows an Alternate Trapdoor 204 that can be used instead of Trapdoor 200. Using an Elastic Member 206, such as spring steel, and a variety of fulcrums and rollers, the Trapdoor Pull Spring 200a, Trapdoor Bumper Spring 200b, and Trapdoor Counterweight 200c (FIG. 5) may be replaced with a single device. The use of multiple springs and bumpers creates a situation where each Trapdoor 200 (FIG. 5) must be separately calibrated and adjusted. An Elastic Member 206 allows for easier manufacturing and assembly by providing a consistent and repeatable force keeping the Alternate Trapdoor 204 in the up position and a different force providing guidance to the Trapdoor Guide 196a (FIG. 6) during transition. With the use of a single Anchor 208, the Forward Fulcrum 210 is placed to provide a weak amount of lift, just enough to keep the Alternate Trapdoor 204 in the up position. A Reverse Fulcrum 212 is placed further along the Elastic Member 206 to provide a greater amount of restorative force during bot transitions. A Primary Roller Guide 214 and Secondary Roller Guide 216 keep the Elastic Member in position through its complete range of motion.

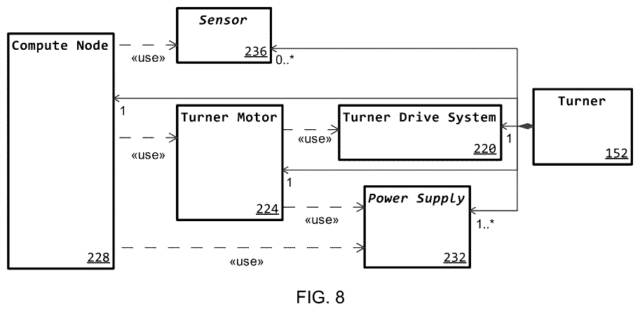

FIG. 8 shows the general design of the Turner 152. The Turner 152 includes a Turner Drive System 220, a Turner Motor 224, a Compute Node 228, one or more Power Supplies 232, and Sensors 236. The design is based on mostly COTS parts. There are some custom Compute Node 228 elements for interfacing with Sensors 236 and the Turner Motor 224, as well as a custom Power Supply 232 for converting the voltage for the Turner Motor to what is required for the Compute Node 228. The Power Supply 232 for the Turner Motor 224 is not necessarily on the Turner 152 itself, but could exist separately, powering multiple turners.

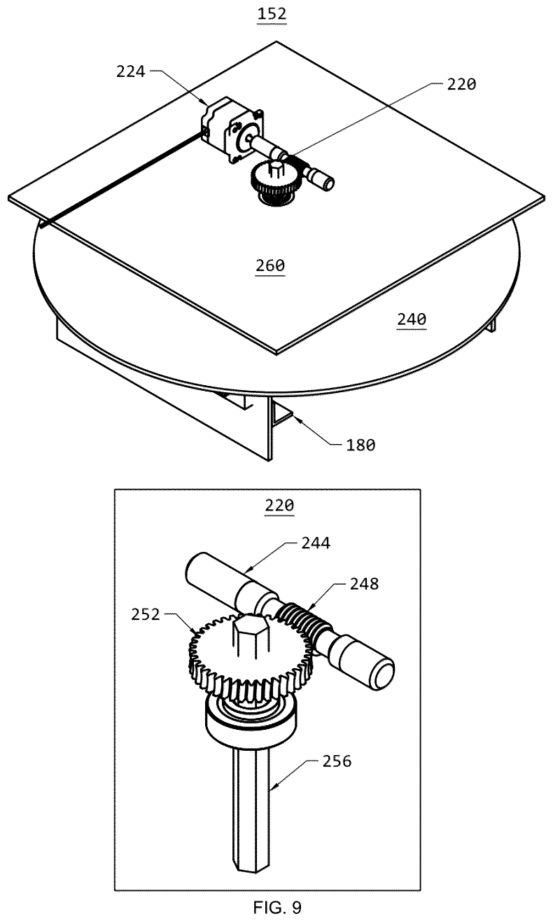

FIG. 9 shows the Turner 152 build. The Turner Motor 224 uses the Turner Drive System 220 to move the Turntable 240. Powered Tracks 180 are attached to the underside of the Turntable 240. The Turner Drive System 220 includes the Turner Drive Shaft 244 which directly connects the Turner Worm 248 to the Turner Worm Gear 252. The Turner Worm Gear 252 is directly attached to the Turntable Shaft 256 which rotates the Turntable 240. This provides for smooth operation between forward and turned orientations and would technically allow for full rotational movement. The Turner Top Plate 260 does not rotate, which allows for electrical and data connections without special considerations for rotation. This design allows for full remote operation or through using an onboard computer. The mechanical connection between the Tuner Top Plate 260 and the Turntable 240 could be further modified with a cam to allow for vertical shifting either during the intermediate phase between forward and turned orientations or between the forward and turned operations themselves.

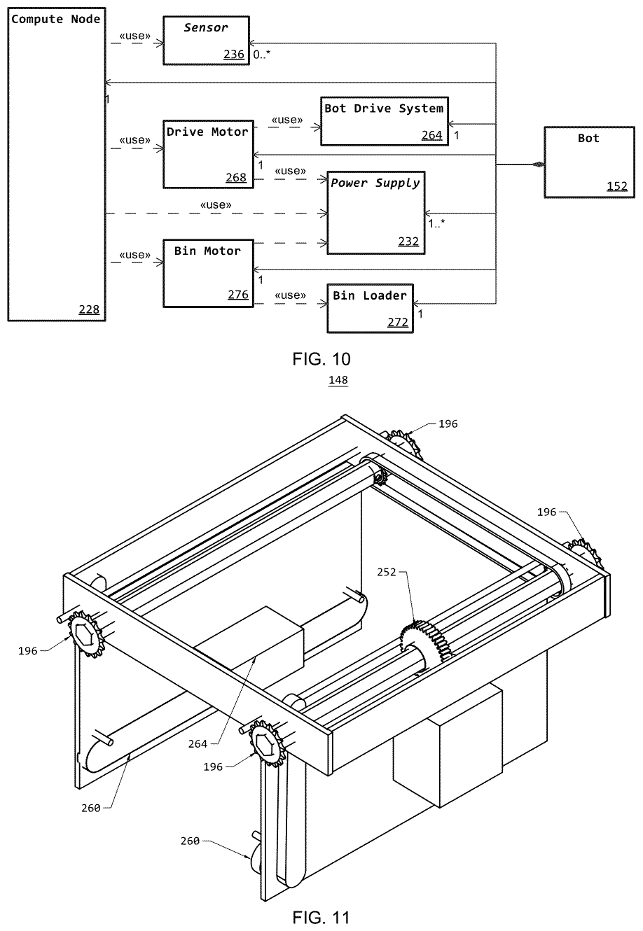

FIG. 10 shows the general design of the Bot 148. The Bot 148 includes a Bot Drive System 264, a Drive Motor 268, a Bin Loader 272, a Bin Motor 276, a Compute Node 228, one or more Power Supplies 232, and Sensors 236.

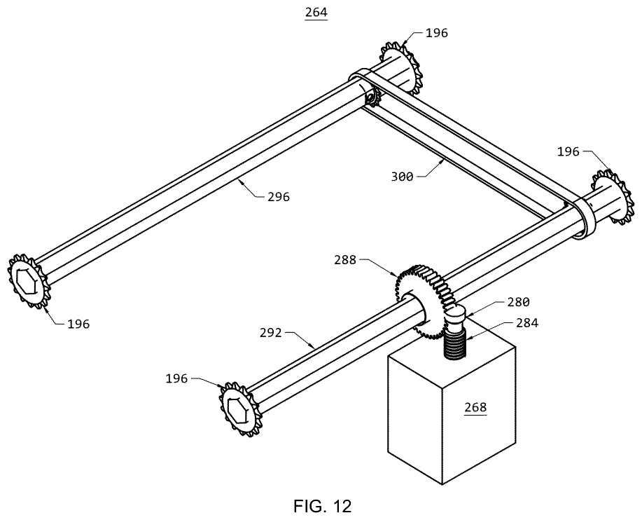

FIG. 11 shows the layout of the improved Bot 148. The 148 includes a reduced number

of Drive Sprockets 196, because the hive design detailed in FIG. 3 only requires forward and backward movement of the Bot 148, instead of also requiring sideways movement as required in U.S. Pat. No. 7,381,022 B1. This has also allowed for a simpler and more robust Bot Drive System 252. For the Bin Loader 260, moving the Bin Motor 264 from the bottom of the Improved Bot 148 allowed for an open-bottom design that allows the Improved Bot 148 to occupy less vertical space while being able to carry larger bins.

FIG. 12 shows the improved Bot Drive System 264 and how it efficiently and reliably transfers mechanical power from the Drive Motor 268. Using a DC servo motor as the Drive Motor 268 allows for fine speed control and removes the need for a motor break. Motor breaks described in the prior art suffer from increased complexity and more maintenance. Consistent with embodiments described herein, the Drive Motor Shaft 280 transfers power with the Drive Worm 284 directly to the Drive Worm Gear 288. The Drive Worm Gear 288 directly drives the Main Axle 292, which is mechanically connected to the Secondary Axle 296 through the Drive Chain 300. The Main Axle 292 and the Secondary Axle 296 are connected to two Drive Sprockets 196 each, providing the four Drive Sprockets 196 necessary for correct operation. Each power transfer interface between rotating members provides a zero-slip interface that allows for efficient power transfer from the Drive Motor 268. The power transfer interface also allows for repeatable movement of the Drive Sprockets 196.

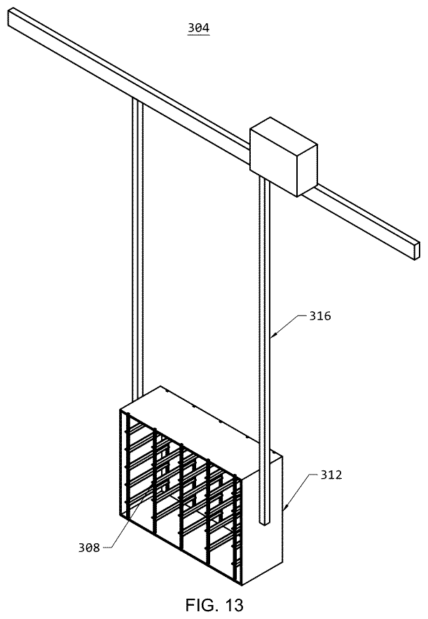

FIG. 13 shows a Delivery Elevator 304 that allows for bots to access the Delivery Shelves 308 without required the bots to make a vertical transition. Instead, the Delivery Module 312 will move along the Delivery Track 316 to change the elevation of the Delivery Module 312 and allow access to different Delivery Shelves 308. This configuration allows the bots to operate at height without having to make any vertical transition. This configuration allows delivery to occur at ground level by moving the Delivery Module 312 to the correct position to deliver goods to customers.

It is understood that while certain embodiments are discussed to facilitate understanding of various principles and aspects of this disclosure, the embodiments are not described in isolation and the descriptions are not necessarily mutually exclusive. Thus, it is contemplated and understood that described features of principles of any embodiment may be incorporated into other embodiments.

It will be apparent to those skilled in the art that various modifications and variations can be made to the disclosed systems. While illustrative embodiments have been described herein, the scope of the invention includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. It is intended, therefore, that the specification and examples be considered as exemplary only, with a true scope and spirit of the invention being indicated by the following claims and their full scope of equivalents.

Glossary of References

| | |
|---|---|
| 100 | Control System |
| 104 | Cloud |
| 108 | Building |
| 112 | Vendor Interface |
| 114a | Web Interface |
| 114b | Mobile Web Interface |
| 114c | Smart Phone Application |
| 114d | On-Site Kiosk |
| 116 | Customer Interface |
| 120 | System Monitoring |
| 124 | Customer Support |
| 128 | Inventory Management |
| 132 | Hive |
| 136 | Storage Matrix |
| 140 | Stocking Interface |
| 144 | Delivery Interface |
| 148 | Bot |
| 152 | Turner |
| 152a | Turner Forward Position |
| 152b | Turner Turned Position |
| 156 | Bin |
| 160 | Controller |
| 164a | Vendor Attestation |
| 164b | Customer Attestation |
| 168 | Item Definition |
| 172 | Purchasing |
| 176 | Location Definition |
| 176a | Location Scan |
| 176b | Geofencing |
| 176c | Location Attestation |
| 180 | Roller Track |
| 182 | N-S Track |
| 184 | E-W Track |
| 186 | Horizontal Track |
| 187 | Vertical Track |
| 188 | Roller |
| 192 | Conductive Backplane |
| 196 | Drive Sprocket |
| 196a | Trapdoor Guide |
| 200 | Improved Trapdoor |
| 200a | Trapdoor Pull Spring |
| 200b | Trapdoor Bumper Spring |
| 200c | Trapdoor Counterweight |
| 200d | Trapdoor Push Plate |
| 200e | Trapdoor Gap |
| 204 | Alternate Trapdoor |
| 206 | Elastic Member |
| 208 | Anchor |
| 210 | Forward Fulcrum |
| 212 | Reverse Fulcrum |
| 214 | Primary Roller Guide |
| 216 | Secondary Roller Guide |
| 220 | Turner Drive System |
| 224 | Turner Motor |
| 228 | Compute Node |
| 232 | Power Supply |
| 236 | Sensor |
| 240 | Turntable |
| 244 | Turner Drive Shaft |
| 248 | Turner Worm |
| 252 | Turner Worm Gear |
| 256 | Turntable Shaft |
| 260 | Turner Top Plate |
| 264 | Bot Drive System |
| 268 | Drive Motor |
| 272 | Bin Loader |
| 276 | Bin Motor |
| 280 | Drive Motor Shaft |
| 284 | Drive Worm |
| 288 | Drive Worm Gear |
| 292 | Main Axle |
| 296 | Secondary Axle |
| 300 | Drive Chain |
| 304 | Delivery Elevator |
| 308 | Delivery Shelves |
| 312 | Delivery Module |
| 316 | Delivery Track |

What is claimed is:

1. A track system for a three-dimensional storage and distributing system comprising:
a track comprising:
a section configured for horizontal operation and a section configured for vertical operation;
a plurality of individual members designed to mesh with a toothed rotational device, the plurality of individual members allowing for a low-vibration interface between the track and the toothed rotational device; and
a gap to allow a passage of a guide during a transition between horizontal operation and vertical operation.

2. The track system of claim 1, wherein each of the plurality of individual members is rounded to encourage the toothed rotational device to slide back to mesh with the plurality of individual members to correct misalignments.

3. The track system of claim 1, wherein each of the plurality of individual members is able to spin to facilitate passage of the toothed rotational device over the plurality of individual members.

4. The track system of claim 1, wherein each of the plurality of individual members is attached to a conductive structural member.

5. The track system of claim 1, wherein the section configured for horizontal operation is interrupted along its length by a plurality of trapdoors.

6. The track system of claim 5, wherein the plurality of trapdoors comprises:
a hinge on a first side;
a mount on a second side configured to bias the hinge in an open position; and
at least one elastic member to allow for biasing, decreased oscillation, and guidance of the toothed rotational device during the horizontal-vertical transition.

7. The track system of claim 5, further comprising a plurality of carriages, each of the plurality of carriages comprising:
a drive system using a motor, wherein the drive system comprises:
four toothed rotational devices;
gearing configured to allow slowing or stopping of the motor;
a drive shaft of the motor for driving a primary axle through a single gear set; and
a secondary axle driven by the primary axle using a non-slip belt or chain.

8. The track system of claim 7, wherein the plurality of carriages further comprise a plurality of rolling guides mounted fore and aft of the toothed rotational device, wherein the plurality of rolling guides engages the plurality of trapdoors during the horizontal-vertical transition.

9. The track system of claim 7, further comprising a plurality of actuated turners, each of the plurality of actuated turners comprising:
a receiver for receiving the plurality of carriages, wherein the receiver is configured to allow for rotating the plurality of carriages in the horizontal plane with or without movement in the y-direction, and wherein the receiver is configured to allow the plurality of carriages to continue operation after the rotation.

10. The track system of claim 9, further comprising a visual acquisition system mounted to each of the plurality of carriages.

11. The track system of claim 10, wherein the visual acquisition system is configured to align the plurality of carriages with the plurality of actuated turners.

12. The track system of claim 9, further comprising:
a plurality of horizontal rails running in the z-direction, wherein the horizontal rails running in the z-direction are interrupted along their length by a second plurality of trapdoors and are connected to the plurality of actuated turners.

13. The track system of claim 7, further comprising:
a plurality of bin manipulators mounted to each of the plurality of carriages, wherein each of the plurality of bin manipulators comprises a framework for transporting bins, wherein the framework for transporting bins comprises an open bottom on the plurality of carriages to allow for transportation of bins of differing heights.

14. The track system of claim 10, wherein the visual acquisition system is configured to:
assist alignment of the plurality of carriages to allow operation of the bin manipulators;
identify unique bins using visual information;
identify presence of bins;
identify absence of bins; and
identify presence of an item within bins using visual information.

15. The track system of claim 7, further comprising a delivery system, wherein the delivery system comprises a plurality of delivery interfaces, the plurality of delivery interfaces comprising:
a delivery shelf configured to:
interact directly with the plurality of carriages operating in the x-direction without moving in the y-direction;
move in the y-direction; and
interact with a customer interface configured to deliver items to respective addresses by consulting a database associating the items with the addresses.

16. The track system of claim 14, further comprising an electronic control system configured to connect the customer interface to a vendor interface, wherein the database comprises inputs from the customer interface and the vendor interface to associate the items with the addresses.

17. The track system of claim 10, wherein the visual acquisition system is configured to align the plurality of carriages with a plurality of delivery shelves.

18. A method comprising:
operating a track, wherein the track comprises:
a section configured for horizontal operation and a section configured for vertical operation;
a plurality of individual members designed to mesh with a toothed rotational device, the plurality of individual members allowing for a low-vibration interface between the track and the toothed rotational device; and
a gap to allow a passage of a guide during a transition between horizontal operation and vertical operation.

19. A non-transitory computer-readable medium storing instructions to perform operations when executed by a processor, the instructions comprising:
operating a track system, where the track system comprises:
a section configured for horizontal operation and a section configured for vertical operation;
a plurality of individual members designed to mesh with a toothed rotational device, the plurality of individual members allowing for a low-vibration interface between the track and the toothed rotational device; and
a gap to allow a passage of a guide during a transition between horizontal operation and vertical operation.
